(19) United States
(12) Patent Application Publication
(10) Pub. No.: US 2025/0086863 A1
(43) Pub. Date: Mar. 13, 2025

(54) PROVIDING MAP ENRICHMENT WITH CROWDSOURCED IMAGERY AND PROGRAMMABLE FUNCTIONALITY THROUGH A MAP SERVICES PLATFORM

(71) Applicant: NVG8 PLATFORM PTE. LTD, SINGAPORE (SG)

(72) Inventor: SYED MOHAMMAD ALI HUSAIN, LEANDER, TX (US)

(21) Appl. No.: 18/829,192

(22) Filed: Sep. 9, 2024

Related U.S. Application Data
(60) Provisional application No. 63/581,392, filed on Sep. 8, 2023.

(51) Int. Cl. G06T 11/60; G01C 21/00

(52) U.S. Cl. CPC G06T 11/60; G01C 21/3841; G01C 21/3848; G01C 21/3859; G06T 2200/24

(57) ABSTRACT

Providing map enrichment with crowdsourced imagery and programmable functionality through a map services platform is disclosed, including receiving imagery from a plurality of contributors; generating one or more map layers utilizing the imagery; and providing a map including the one or more map layers to a user interface.

### BACKGROUND

Conventional map vendors rely on satellite imagery that has limited resolution and is updated infrequently, as well as street imagery that is static and collected infrequently. For example, it might take a company like Google™ years to update their street view imagery in some areas. Further, conventional map vendors do not provide mechanisms for the user to automate the map viewing experience, or for a data provider to provide an automated and dynamically customized map viewing experience to a user.

### SUMMARY

Methods, apparatuses, and products for providing map enrichment with crowdsourced imagery and programmable functionality through a map services platform according to various embodiments are disclosed. A map services platform in accordance with the present disclosure collects and utilizes crowdsourced high-quality imagery from individual contributors to create an immersive, constantly-refreshing view of the world. By leveraging contributors' data, the map services platform provides data sets that go far beyond those provided by conventional mapping vendors, giving users access to ultra-high-definition aerial imagery that is constantly updated and surpassing traditional satellite-based map offerings on the web. The map services platform further gives users access to dashcam video that is constantly updated and surpasses the static views provided by conventional mapping vendors. In some examples, the map services platform also includes a scripting engine for programming maps to generate dynamic and customized maps and to automate the map viewing experience. In some examples, the map services platform also includes a natural language interface through which a user can interact with a map assistant to make natural language requests and get natural language responses along with maps programmed based on the user's request.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example system for [preamble in accordance with at least one embodiment of the present disclosure.

FIG. 2 is a block diagram of an example system for providing map enrichment with crowdsourced imagery and programmable functionality through a map services platform in accordance with at least one embodiment of the present disclosure.

FIG. 3 is a flowchart of an example method for providing map enrichment with crowdsourced imagery and programmable functionality through a map services platform in accordance with at least one embodiment of the present disclosure.

FIG. 4 is a flowchart of an example method for providing map enrichment with crowdsourced imagery and programmable functionality through a map services platform in accordance with at least one embodiment of the present disclosure.

FIG. 5 is a flowchart of an example method for providing map enrichment with crowdsourced imagery and programmable functionality through a map services platform in accordance with at least one embodiment of the present disclosure.

### DETAILED DESCRIPTION

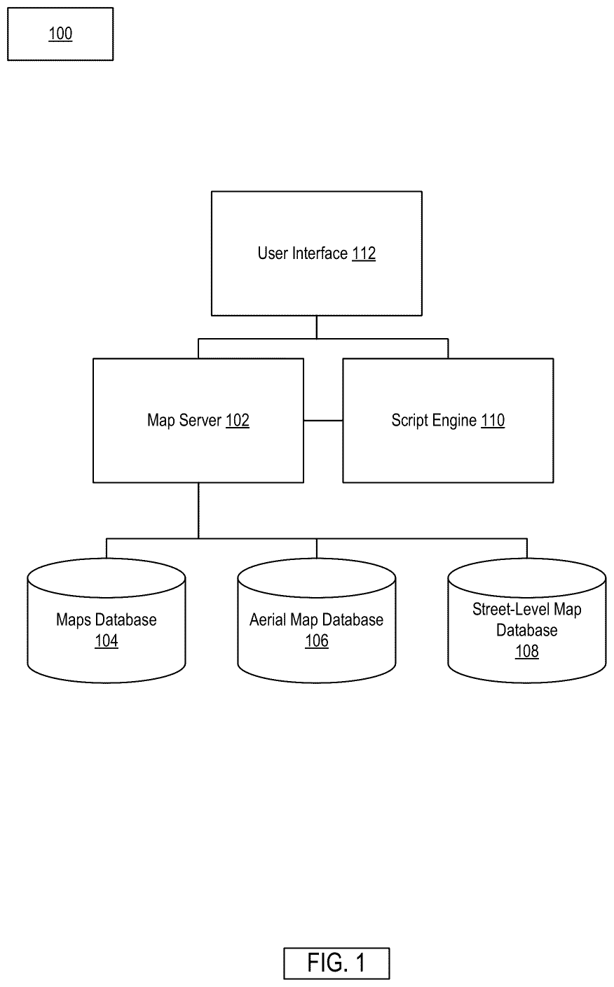

Exemplary apparatuses, systems, and methods for providing map enrichment with crowdsourced imagery and programmable functionality through a map services platform in accordance with the present disclosure are described with reference to the accompanying drawings, beginning with FIG. 1. FIG. 1 sets forth a block diagram of a map services platform 100. The map services platform 100 includes a map server 102 that provides enriched map data to a user through a user interface 112. The map server 102 may be configured to receive imagery from a plurality of contributors; generate one or more map layers utilizing the imagery; and provide a map including the one or more map layers to a user interface. The map server may also be configured to provide a script console for a map script execution engine; receive a user-defined map script via the script console; and execute the user-defined script on a map. The map server 102 utilizes map data from a map database 104 that provides map elements such as locations, landmarks, roadways, terrain, public transportation routes, etc. overlaid on a geographic coordinate system of longitude and latitude coordinates. The map server 102 also utilizes map data from an aerial map database 106 to provide an enriched layer of aerial imagery. The map server 102 also utilizes map data from a street-level database 108 to provide an enriched layer of street-level imagery.

The aerial map database 106 includes aerial imagery contributed by individual users. For example, the aerial imagery may be images captured by drones. In some examples, users can contribute to the aerial map database by uploading drone imagery through the user interface 112 or a separate upload interface. Uploaded imagery is ingested the map services platform 100 where it is cleaned, processed and mosaicked with other imagery to provide a high-resolution map of the world. In some examples, the enriched aerial imagery may be added as a layer on top of satellite imagery. Through the user interface 112, the user may toggle views to compare the satellite imagery to the drone imagery. The user interface 112 may also display details about the image such as the elevation at capture, the timestamp of the image capture, the bounding box coordinates of the image, as well as the user that submitted the image.

The street-level map database 108 includes street-level imagery contributed by individual users. For example, the street-level imagery may include images and video captured by dashboard cameras, action cameras, smart phones, etc. In some examples, users can contribute to the street-level map database by uploading GPS-tracked video through the user interface 112 or a separate upload interface. Uploaded imagery is ingested the map services platform 100 where it is cleaned, processed and mosaicked with other imagery. In some examples, the enriched street-level imagery may be added as a layer on top of satellite or other imagery. Through the user interface 112, the user may click into a particular video capture on the map and view the video while seeing the location change on the map as the location changes in the video. For example, in a map view, the user may click into a particular video capture for a roadway and see video taken from a vehicle dashcam as the vehicle drives on the road. As the video progresses along the roadway, the location corresponding to the video display is also updated in the map view.

In some examples, imagery contributions to the map services platform 100 are recorded on chain and trigger user rewards in the form of tokens. Through the map services platform API, developers or other users can use these tokens to access the data stored in map databases. Imagery uploaded to the map services platform 100 is not limited to data collected by drones and dashcams, but may include any number of data sources such as robotics, autonomous vehicles, IoT sensors, and so on.

The map services platform 100 also includes a script engine 110 that can be used to program maps by executing a script on the map. The script engine 110 executes code written in a map script language. The script language provides a simple and intuitive syntax for common map-related tasks such as adding markers, adding GeoJSON objects, changing the map style, and so on. The script language includes primitives for numbers, strings, Boolean values, arrays, and objects (e.g., collections of key-value pairs). The map services platform 100 may include a script engine console that may be a part of the user interface 112. In some examples, the script engine console is a command-line interface (CLI) that allows the user to enter commands by typing them into a command prompt. Each command corresponds to a specific action or function that the scripting engine can perform. The commands are structured with a specific syntax and may include options, arguments, and parameters to specify the desired behavior.

The map script language may include a sleep function that is used to pause execution of the script for a given number of milliseconds. The sleep function may take the format ‘sleep(milliseconds: number).’ For example, ‘sleep(1000)’ pauses the execution of the script for 1 second.

The map script language may also include a zoom function that is used to zoom the map to a specific level. The zoom function may take the format ‘zoom(level: number)’ where the ‘level’ argument is a range of zoom levels. For example, ‘zoom(10)’ zooms the map to level 10. The

The map script language may include a style setting function that is used to change the style of the map, such as graphical, satellite (and aerial), or street view. The set style function may take the format ‘setStyle(style: string)’ where the ‘style’ argument is, for example, ‘satellite’ or ‘street.’ For example, ‘setStyle(‘satellite’)’ changes the map style to satellite view.

The map script language may also include a move location function that is used to move the map to a specific location. The move location function may take the format ‘moveLocation(coordinates: [number, number])’ where the coordinates argument must be an array of two numbers representing the longitude and latitude of the location. For example, ‘moveLocation([−122.4194, 37.7749])’ moves the map to San Francisco

The map script language may also include a function to add text to the map at a specific location. The function to add text may take the format ‘addText(text: string, locationOnMap: [number, number])’ where the ‘text’ argument must be a string and the ‘locationOnMap’ argument must be an array of two numbers representing the longitude and latitude of the location. For example, ‘addText(‘Hello, World!’, [−122.4194, 37.7749])’ adds the text ‘Hello, World!’ to San Francisco on the map.

The map script language may also include a rotate function that is used to rotate the map to a specific bearing (in degrees). The rotate function may take the format ‘rotateTo(bearing: number).’ For example, ‘rotateTo(90)’ rotates the map 90 degrees clockwise.

The map script language may also include a function to add a geographic javascript object notation (geoJSON) source to the map. GeoJSON is a format for encoding a variety of geographic data structures. The function may take the format ‘addGeojson(name: string, geojson: object)’ where the ‘name’ argument must be a string and the ‘geojson’ argument must be a valid GeoJSON object. The map script language may also include a function to remove a GeoJSON from the map. The function may take the format ‘removeGeojson(name: string)’ where the ‘name’ argument is the name of the layer to remove.

The map script language may also include a function to add a marker to the map. The function may take the format ‘addMarker(coordinates: [number, number], color: string)’ where the ‘coordinates’ argument is an array of two numbers representing the longitude and latitude of the marker's position on the map. The ‘color’ argument is a string representing the color of the marker. The color can be specified as a hex code or as a named color. For example,

The map script language may also include a function to add a marker to the map that, when clicked, displays a video player with the specified video URL. The function may take the format ‘addVideo(coordinates: [number, number], url: string)’ where the ‘coordinates’ argument is an array of two numbers representing the longitude and latitude of the marker's position on the map and the ‘url’ argument is a string representing the URL of the video to be played.

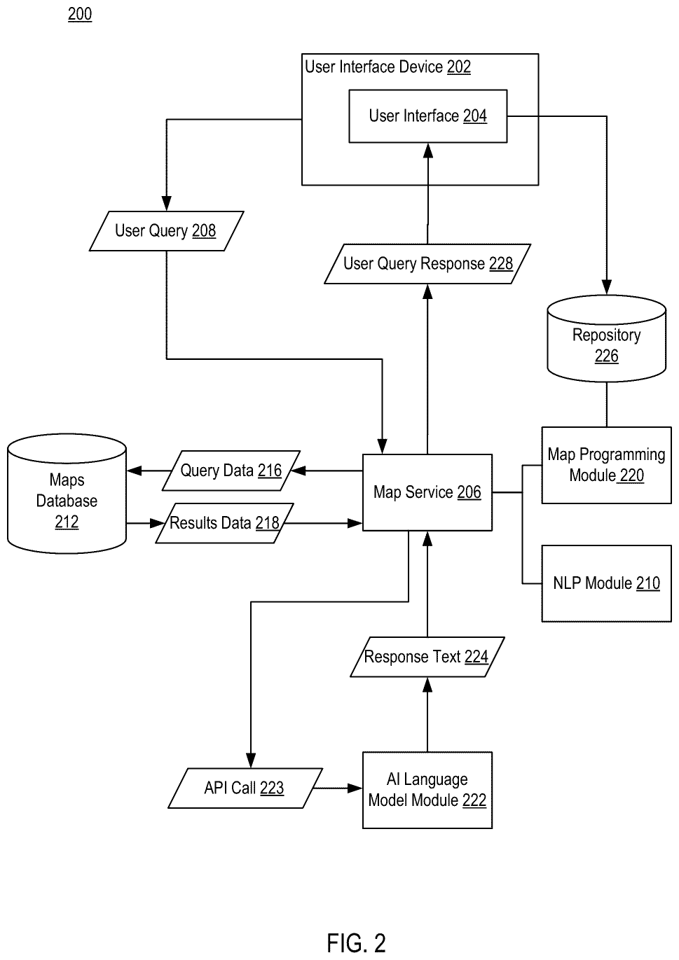

For further explanation, FIG. 2 is a block diagram of an example map services platform 200 for providing map enrichment with crowdsourced imagery and programmable functionality through a map services platform in accordance with at least one embodiment of the present disclosure. A user can interact with the map services platform 200 using natural language to request and receive maps that are programmed based on the content of their request. For example, a user can query the map services platform 200 in natural language and receive a natural language response along with a link to a programmed map based on the results of the query.

The platform of FIG. 2 includes a user interface device 202 that provides a user interface 204. The user interface device 202 may be, for example, a desktop or laptop computer, a smartphone, a tablet, a voice assistant device such as a vehicle voice assistant or smart speaker, or other such devices. The user interface 204 enables user interaction with the map services platform 200 through a web-based interface, mobile app, or speech interface. Thus, the user interface 204 may embody one or more of the following aspects: a graphical user interface (GUI) that utilizes visual elements such as icons, buttons, menus, and text fields to present information and enable user interactions with the map services platform 200; a text-based interface where users interact by typing instructions or questions to the map services platform 200; voice user interface (VUI) that enables users to interact with the map services platform 200 using spoken commands or natural language; and a natural language user interface that combines elements of VUI and text-based interfaces and employs language processing algorithms to convert speech to text and text to speech, thus allowing users to interact with the map services platform 200 using written or spoken natural language. In a particular embodiment, the user provides natural language queries, either spoken or written queries, to the map services platform 200 via the user interface 204. The user interface 204 is configured to interact with a map service 206 by calling to an API exposed by the map service 206 to submit a query 208. To aid illustration, consider a first example where a user speaks or types the query “I'm at Waterloo Park in Austin TX. I'm a big geocaching buff and want to explore geocaches around my location. Could you make a plan for me and share a map/image?” In response, the user interface 204 calls to an interface of the map service 206 with the query 208 included as an API parameter.

The map service 206 may include one or more applications or application modules residing on a server or in cloud-based computing resources. For example, the map service 206 may be embodied in a set of computer program instructions that, when executed by a computing device, cause the computing device to carry out the functions of receiving a natural language query via a user interface; generating a programmed map based on the natural language query; and providing a natural language response to the natural language query in association with a link to the programmed map.

The map service 206 is configured to receive a query 208 through one or more APIs exposed by the map service 206. In some examples, the map service 206 includes an NLP module 210 that parses the query 208 and extracts the intent. For example, the NLP module 210 may extract tokens and classify those tokens based on the type of information, such as search terms, search constraints, or contextual information. Examples of search terms may include a category of locations (e.g., music venues, restaurants open after 10 pm, art museums, geocaches etc.) or other such data points. Examples of search constraints may include a start location, a destination, a waypoint, a search area (e.g., a city, neighborhood, zip code), a proximity (e.g., within 3 miles of a particular location), a route (e.g., search along route), or other boundary information that can be inferred from the query. Examples of contextual information may include words that indicate whether the user is requesting a map of locations, vehicle navigation directions between a start and destination, a walking route, and so on. Continuing the first example, the map service 206 may determine that “geocaches” is the category of location that is the target of the search and that the search area is a 3 mile radius of Waterloo Park in Austin, TX. The map service 206 may also determine from contextual information provided the word “plan” that the user is requesting a route starting and ending at Waterloo Park with the identified geocache locations as waypoints along the route.

The map service 206 uses a variety of data sources to generate response data for the query 208. For example, the map service 206 may query a map database 212 and/or a public search engine with query data 216 based on the tokens that were extracted from the query 208. For example, the map service 206 may formulate a query data 216 that identifies a search area and requests locations within that search area that match the search terms. In another example, the map service 206 may formulate a query that uses the starting location and destination location for a route to identify points on the route that match the search terms. Continuing with the first example, the map service 206 may query the data sources with query data that includes a structure query such as generateRoute(“geocaches” WITHIN(3 miles) “Waterloo Park in Austin, TX”).

In response to the query data 216, the map service 206 receives results data 218 from the map database 212. The results data 218 for the query may include a map annotated with location markers or geoJSON objects corresponding to search term hits, navigation directions or routes, and other location data responsive to the query data 216. In some examples, the map is an enriched map, as discussed above, in that the map may include one or more of a graphical layer, an aerial view layer, and a street view layer. The aerial view layer may be enriched with aerial imagery collected by drones, particularly drones of individuals that submit the imagery to the map services platform 200, as discussed above. The street view layer may be enriched with dashcam imagery, particularly imagery collected by vehicles of individuals that submit the imagery to the map services platform 200, as discussed above. Continuing with the first example, the results data 218 may include locations and a route for visiting all geocache locations within a 3 mile radius of Waterloo Park, with Waterloo Park as the start and end point of the route.

In some examples, the result data 218 is provided to a map programming module 220 for map program generation based on the results data 218. For example, the map programming module 220 may generate a script that moves to each location result on the map of the result data 218. As one example, the script may program the map to move to a first location, zoom in, wait for specified amount of time, move to the next location, zoom in, and so on. In some examples, the map programming module 220 may add geoJSON objects to the map. For example, a geoJSON object may be added to indicate properties of the location result such as store hours, parking rules, points of interest, famous menu items, or other information about the location result. In some examples, the script generated by the map programming module 220 may toggle between graphical, aerial, and street views to provide an enhanced visualization. The map service 206 then stores an image of the map and the programmed map in a publicly accessible repository 226. Continuing with the first example, where the exact locations of geocaches may not be known, the map programming module 220 may generate a script that adds geoJSON objects representing the general location of each geocache, display a graphical representation of the route to the next geocache, toggle to an aerial view, zoom in to show detail, toggle to a street view for additional context, and then move to the next geocache location.

In some examples, the map service 206 generates response text using an AI language model 222. For example, the map service 206 may call a language model API (e.g., the chatGPT API) to submit the user's original query text with an API call 223 and receive intelligent response text 224 for responding to the user query. As one example, the map service 206 may call the language model API with the user text “show me a map of the top 10 tourist sites in Austin, TX” and receive response text 224 such as “I would be happy to provide you with that information, the top 10 tourist sites are . . . . Here is a map that shows you the shortest route to visit all 10 sites.” In some examples, the map service 206 trains the language model to respond to the query text by providing examples for a system role, an assistant role, and a user role. Using a description of the system role for context and example user queries and desired assistant responses, the language model can learn the desired responses for user queries. Continuing the first example, in response to submitting the user query 208 using the language model API, the response text 224 might read “Certainly! Here's a geocaching route for you to explore geocaches around Waterloo Park in Austin, TX. Remember to bring your geocaching tools, such as a GPS device or smartphone with the Geocaching app, a pen to sign the logbook, and any swappable items you'd like to exchange.”

In some examples, the map service generates a user query response 228 that includes the response text 224, an image of the map generated in response to the query, and a link to the programmable map in the programmed map in the publicly accessible repository 226. The map service sends the user query response 228 to the user interface 204. In the case of a desktop, laptop, tablet, or mobile phone, the response text 224, map image, and link to the programmable map may be displayed in the user interface 204. In the case of a voice assistant, the response text 224 may be read aloud to the user, and the map image and link to the programmed map may be emailed to the email address of the user that is registered with the voice assistant account. Continuing the first example, the response text 224 and static map image of the route for visiting the geocache sites may be displayed on the user device with a link to the programmed map in the publicly accessible repository 226.

In an alternative embodiment, the user interface 204 includes a natural language model. The natural language model performs NLP to interpret the user query and generates one or more intelligent API calls to an API exposed to the map service 206. The map service 206 generates results and a programmed map as discussed above, and provides a link to the programmed map to the user interface 204. The natural language model of the user interface 204 generates the response text and includes the link to the programmed map.

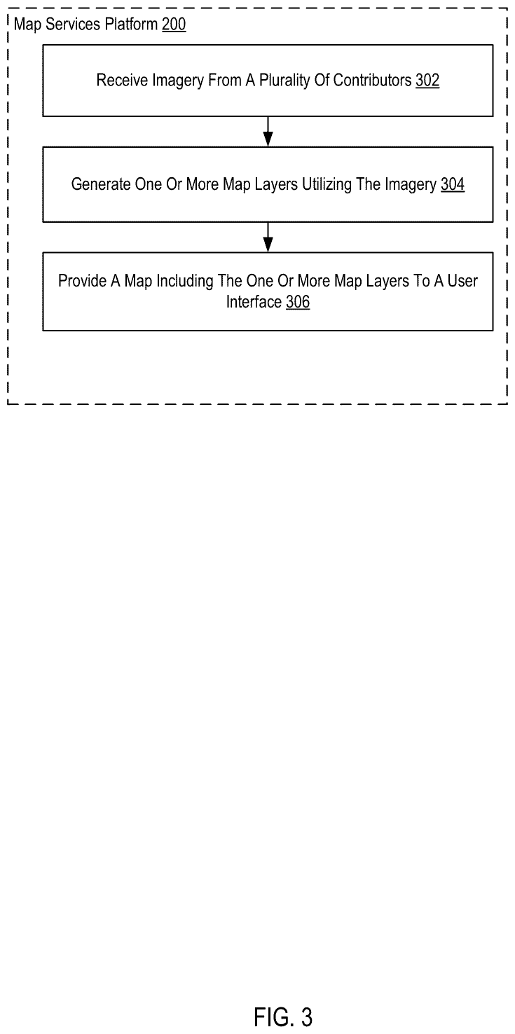

For further explanation, FIG. 3 sets forth a flow chart for an example method of providing map enrichment with crowdsourced imagery and programmable functionality through a map services platform in accordance with at least one embodiment of the present disclosure. The method of FIG. 3 includes receiving 302 imagery from a plurality of contributors. In some examples, receiving 302 the imagery from the plurality of contributors is carried out as discussed above. The method of FIG. 3 also includes generating 304 one or more map layers utilizing the imagery. In some examples, generating 304 one or more map layers utilizing the imagery is carried out as discussed above. The method of FIG. 3 also includes providing 306 a map including the one or more map layers to a user interface. In some examples, providing 306 a map including the one or more map layers to a user interface is carried out as discussed above. The imagery may include still imagery and video imagery. The one or more map layers include an aerial layer and a street-level map layer. In some examples, the aerial map layer includes imagery captured by one or more drones of one or more contributors. In some examples, the street-level map layer includes imagery captured by one or more dashboard cameras of one or more contributors. The street-level map layer may include imagery captured by a mobile device of one or more contributors. The imagery may be associated with GPS coordinates, and the one or more map layers may be generated using the GPS coordinates of the imagery.

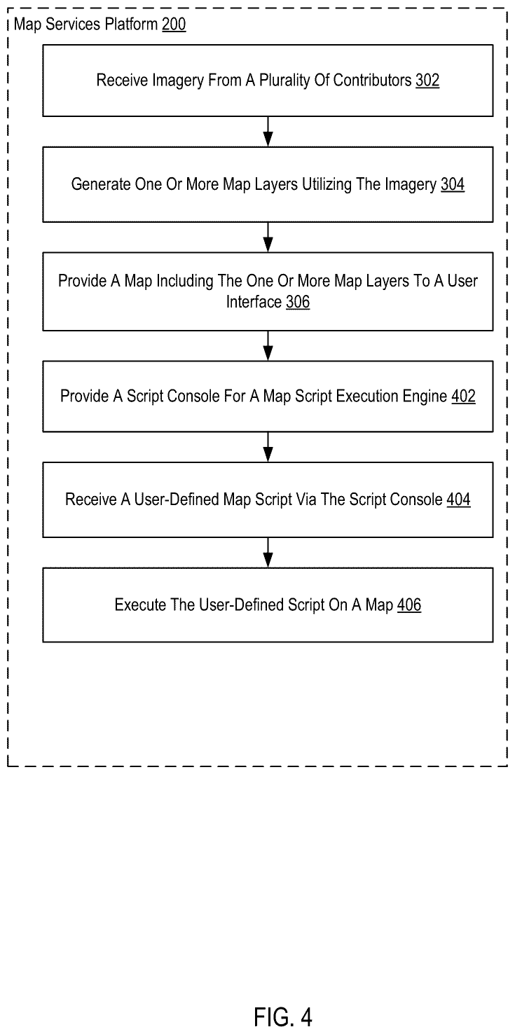

For further explanation, FIG. 4 sets forth a flow chart for an example method of providing map enrichment with crowdsourced imagery and programmable functionality through a map services platform in accordance with at least one embodiment of the present disclosure. The method of FIG. 4 includes providing 402 a script console for a map script execution engine. In some examples, providing 402 a script console for a map script execution engine is carried out as discussed above. The method of FIG. 4 also includes receiving 404 a user-defined map script via the script console. In some examples, receiving 404 a user-defined map script via the script console is carried out as discussed above. The method of FIG. 4 also includes executing 406 the user-defined script on a map. In some examples, executing 406 the user-defined script on a map is carried out as discussed above.

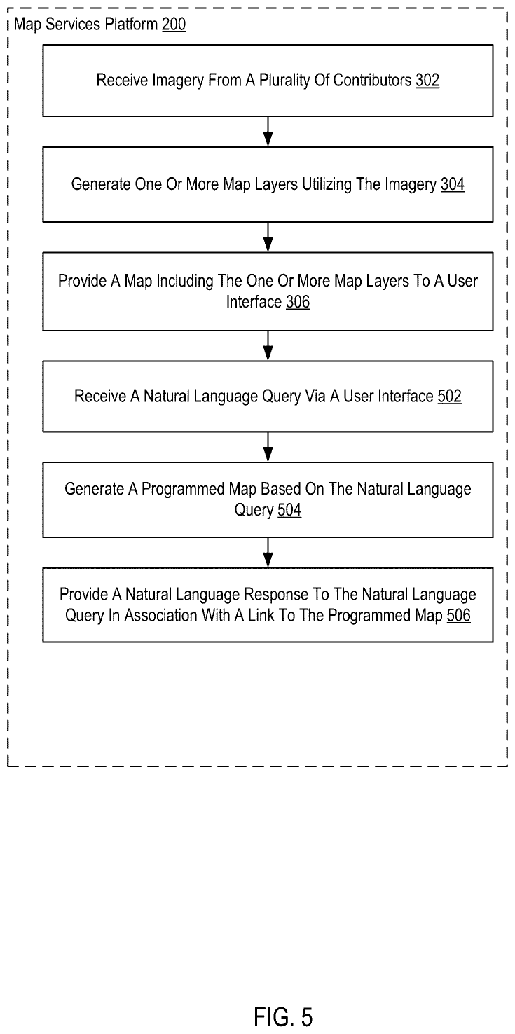

For further explanation, FIG. 5 sets forth a flow chart for an example method of providing map enrichment with crowdsourced imagery and programmable functionality through a map services platform in accordance with at least one embodiment of the present disclosure. The method of FIG. 5 includes receiving 502 a natural language query via a user interface. In some examples, receiving 502 a natural language query via a user interface is carried out as discussed above. The method of FIG. 5 also includes generating 504 a programmed map based on the natural language query. In some examples, generating 504 a programmed map based on the natural language query is carried out as discussed above. The method of FIG. 5 also includes providing 506 a natural language response to the natural language query in association with a link to the programmed map. In some examples, providing 506 a natural language response to the natural language query in association with a link to the programmed map is carried out as discussed above. The programmed map may be generated by generating a structured query from the natural language query, generating a map script based on results of the structure query from map database, and executing the map script on a map.

Exemplary embodiments of the present disclosure are described largely in the context of a fully functional computer system for providing map enrichment with crowdsourced imagery and programmable functionality through a map services platform. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of providing map enrichment with crowdsourced imagery and programmable functionality through a map services platform, the method comprising:
receiving imagery from a plurality of contributors;
generating one or more map layers utilizing the imagery; and
providing a map including the one or more map layers to a user interface.

2. The method of claim 1, wherein the imagery includes still imagery and video imagery.

3. The method of claim 1, wherein the one or more map layers include an aerial layer and a street-level map layer.

4. The method of claim 3, wherein the aerial map layer includes imagery captured by one or more drones of one or more contributors.

5. The method of claim 3, wherein the street-level map layer includes imagery captured by one or more dashboard cameras of one or more contributors.

6. The method of claim 5, wherein the street-level map layer includes imagery captured by a mobile device of one or more contributors.

7. The method of claim 1, wherein the imagery is associated with GPS coordinates, and wherein the one or more map layers are generated using the GPS coordinates of the imagery.

8. The method of claim 1 further comprising:
providing a script console for a map script execution engine;
receiving a user-defined map script via the script console; and
executing the user-defined script on a map.

9. The method of claim 1 further comprising:
receiving a natural language query via a user interface;
generating a programmed map based on the natural language query; and
providing a natural language response to the natural language query in association with a link to the programmed map.

10. The method of claim 9, wherein the programmed map is generated by generating a structured query from the natural language query, generating a map script based on results of the structure query from map database, and executing the map script on a map.

11. A system for providing map enrichment with crowdsourced imagery and programmable functionality through a map services platform, the map services platform comprising:
one or more map servers; and
one or more map databases;
wherein the one or more servers are configured to:
receive imagery from a plurality of contributors;
generate one or more map layers utilizing the imagery; and
provide a map including the one or more map layers to a user interface.

12. The system of claim 11, wherein the imagery includes still imagery and video imagery.

13. The system of claim 11, wherein the one or more map layers include an aerial layer and a street-level map layer.

14. The system of claim 13, wherein the aerial map layer includes imagery captured by one or more drones of one or more contributors.

15. The system of claim 13, wherein the street-level map layer includes imagery captured by one or more dashboard cameras of one or more contributors.

16. The system of claim 15, wherein the street-level map layer includes imagery captured by a mobile device of one or more contributors.

17. The system of claim 11, wherein the imagery is associated with GPS coordinates, and wherein the one or more map layers are generated using the GPS coordinates of the imagery.

18. The system of claim 11, wherein the one or more servers are further configured to:
provide a script console for a map script execution engine;
receive a user-defined map script via the script console; and
execute the user-defined script on a map.

19. The system of claim 11, wherein the one or more servers are further configured to:
receive a natural language query via a user interface;
generate a programmed map based on the natural language query; and
provide a natural language response to the natural language query in association with a link to the programmed map.

20. The system of claim 19, wherein the programmed map is generated by generating a structured query from the natural language query, generating a map script based on results of the structure query from map database, and executing the map script on a map.
